(19) United States
(12) Patent Application Publication
(10) Pub. No.: US 2002/0016418 A1
(43) Pub. Date: Feb. 7, 2002

(54) Curable coating compositions and methods of forming coating films

(76) Inventors: Tsutomu Maruyama, Hiratsuka-shi (JP); Tetsuo Ogawa, Hiratsuka-shi (JP)

Correspondence Address: Huntley & Associates, P.O. Box 948, Wilmington, DE, 19899-0948, US

(21) Appl. No.: 09/809,817

(22) Filed: Mar. 16, 2001

(30) Foreign Application Priority Data
Mar. 16, 2000 (JP) 12/748530

(51) Int. Cl. C08F 8/42; C08F 8/12; C08F 8/28; C08F 8/14

(52) U.S. Cl. 525/326.6; 525/342; 525/383; 525/385; 525/386

(57) ABSTRACT

A coating composition curable by actinic radiation, heat or both comprising a polymer containing an alkoxysilyl group having a weight average molecular weight of from about 500 to more than 10,000, a Radical reactivity compound, a cationic polymerization initiator, and an optional radical polymerization initiator and cationic reactivity compound.

### BACKGROUND OF THE INVENTION

The present invention relates to cationic reactivity compositions, cationic or radical hybrid reactivity compositions, curable coating compositions and a method of forming a curable coating compositions. A curable coating composition of the present invention has a variety of desirable characteristics, including low viscosity, good workability, good surface curing properties and can provide a cured film having high hardness.

Paints and lacquers have been known that can be cured by actinic radiation. Generally a radical polymerization component and a cationic polymerization component are used for compositions curable with actinic energy. Such actinic radiation curing is widely used today. However, the adhesive properties of previous coatings cured by actinic radiation are often not satisfactory. In addition, in such previous coatings, the contraction rate during curing can be too high.

Cationic polymerization coatings can exhibit generally satisfactory curing and adhesion properties for a substrate, but can be deficient in coatings that involve radical polymerization reactions. Cationic polymerization components can suffer from inferior curing of thick films, susceptibility to the effects of contamination, especially from water and ions, and a slow curing speed, all as compared to radical polymerization reactions. The defects of the cationic polymerization type are not fully cured by combining with a radical polymerization composition.

### SUMMARY OF THE INVENTION

The present invention provides coating compositions that can be cured by heating or by actinic energy radiation and which exhibit excellent cured film properties, including hardness, adhesion to substrates, and resistance to chemicals. For example, the curable composition can be used in paints, inks, adhesives and other applications. The actinic energy for curing can include ultraviolet rays or electron beams.

The present invention is based on the discovery of the unique desirability, in such compositions, of the combination of a radical reactivity compound, a cationic polymerization initiator, a radical polymerization initiator, and a cationic reactivity compound.

Specifically, the present invention provides curable coating compositions comprising (A) 10-100 parts by weight of a polymer containing an alkoxysilyl group of weight average molecular weight of from about 500 to more than 10,000, and having at least one alkoxysilyl group in each molecule, (B) 0-90 parts by weight of a cationic reactivity compound, and (C) 0.05-20 parts by weight of a cationic polymerization initiator.

The present invention also provides curable coating compositions comprising (A) 10-99.5 parts by weight of a polymer containing an alkoxysilyl group of weight average molecular weight of from about 500 to more than 10,000, and having at least one alkoxysilyl group in each molecule, (B) 0.5-90 parts by weight of a radical reactivity compound, (C) 0.05-20 parts by weight of a cationic polymerization initiator, and (D) 0.05-20 parts by weight of a radical polymerization initiator.

In addition, the present invention provides a curable coating composition comprising (A) 10-100 parts by weight of a polymer containing an alkoxysilyl group of weight average molecular weight of from about 500 to more than 10,000, and having at least one alkoxysilyl group in each molecule, (B) 0.5-90 parts by weight of a radical reactivity compound, (C) 0.05-20 parts by weight of a cationic polymerization initiator, (D) 0.05-20 parts by weight of a radical polymerization initiator, and (E) 0-90 parts by weight of a cationic reactivity compound.

The present invention provides a method of forming a curable coating composition comprising obtaining one of the curable coating compositions of the invention described above, applying the composition to a substrate, and curing the composition by applying actinic radiation, heat, or a combination of both.

### DETAILED DESCRIPTION OF THE INVENTION

The polymer in the present invention contains an alkoxysilyl group having a weight average molecular weight of from about 500 to more than 10,000, and a preferred weight average molecular weight of about from 600 to 5,000. The polymer should have at least one alkoxysilyl group, and preferably 3-50 such groups, in each molecule. When the content of alkoxysilyl groups is, on average, less than about one, the curability and resistance to scratches are inferior.

When the weight average molecular weight becomes less than about 500, the physical properties of the coating, and the workability thereof, become inferior. Similar deficiencies are noted when a weight average molecular weight of about 10,000 is exceeded.

The polymers of the present invention can be produced by various methods, including normal radical polymerization. When using a polymer of low molecular weight, the ethylenically unsaturated group comprising Oligomer (a-1) can be polymerized, in preferred embodiments, by Catalytic Chain Transfer Polymerization (hereinafter called a CCTP method), or by radical polymerization reactant (Oligomer (a-2) ) with other monomer and the Oligomer (a-1). The polymer (A) can also contain two or more cationic reactivity functional groups in each molecule. For example, the CCTP method is described by Japanese Patent Publication No. 6-23209, Japanese Patent Publication No. 7-35411, JP-T 9-501457 issue, Japanese Patent Laid-Open No. 9-176256 issue, Macromolecules 1996,29, page 8083-8089. The CCTP method can polymerize an unsaturated monomer in non solvent or organic solvent. Solvents that can be used include those having a metallic complex of catalytic chain transfer agent and a radical polymerization initiator. The various s 5 CCTP methods that can be used according to the present invention are described in detail in the above publications.

Examples of metallic complexes that can be used according to the CCTP method can include cobalt complex, iron complex, nickel complex, ruthenium complex, rhodium complex, palladium complex, rhenium complex, and iridium complex. Metallic complexes having good efficiency are preferable, as is a cobalt complex acting as a chain transfer agent. A cobalt complex is preferred because it is an efficient chain transfer agent. Examples of cobalt complexes that can be used include those described in Japanese Patent Publication No-6-23209, Japanese Patent Publication No. 7-35411, U.S. Pat. No. 4,526,945, U.S. Pat. No. 4,694,054, U.S. Pat. No. 4,837,326, U.S. Pat. No. 4,886,861, U.S. Pat. No. 5,324,879, W.O. 95/17435, and Japanese Patent Publication No. 9-510499.

Other examples of cobalt complexes that can be used include, for example, bis (boron difluoro dimethyl dihydroxy imino cyclohexane) cobalt (II), bis(boron difluoro dimethyl glyoximate) cobalt (II), bis(boron difluoro diphenyl glyoximate) cobalt (II), cobalt (II) chelate of vicinal 1-imino hydroxy imino compound, cobalt (II) chelate of tetra azatetraalkyl cyclo tetradecatetraerie, N,N′-bis(salicylidene) ethylene diamino cobalt (II) chelate, cobalt (II) chelate of dialkyl diazadi oxo dialkyl dodecadiene, cobalt (II) porphyrin complex. Of these, preferred cobalt complexes include bis(boron difluoro diphenyl glyoximate) Co (II) and bis(boron difluoro dimethylglyoximate) cobalt (II), both being easily available.

In addition, other metallic complexes that can be used include those where direct radical cleavage is possible and those described by Japanese Patent Publication No. 8-19172. Among the groups where radical cleavage is possible are alkyl, aryl, and heterocyclic groups. Still other metal complexes which can be used include substitution derivative which have a homlytec cleavage from metal ionizable by visible light or exposure and application of heat or ultra-violet radiation; the halide which is connected in chelate metal ion, other anions, nitrile, ester, aromatic substituted for with the carbon atom which connected in metal ion or substitution aromatic group. Even if, in a type using the metallic complex group where direct radical cleavage is possible, radical polymerization is not always used together. The Oligomer (a-1) used as CCTP resin (A) can produce alkoxysilyl group comprising polymerization unsaturation monomer (M-1) or the other unsaturated ethylene monomers (W-2) which can be copolymerized by the CCTP method.

Alkoxysilyl group comprising polmerization unsaturation monomer

Alkoxysilyl group comprising polymerization unsaturation monomer (M-1) is a monomer which can be used in order to introduce an alkoxysilyl group in the oligomer.

Representative examples of such groups include alkoxysilyl groups comprising polymerizable unsaturated compounds such as vinyl trimethoxysilane, vinyltriethoxysilane, vinylmethyldimethoxy silane, vinylmethyldiethoxysilane, γ-(meta)acryloyloxypropyl trimethoxysilane, γ-(meta)acryloyloxypropylmethyl, di-methoxysilane, γ-(meta)acryloyloxypropylmethyldiethoxy silane, γ-(meta)acryloyloxypropyltriethoxysilane, β-(meta)acryloyloxyethyltrimethoxysilane, γ-(meta)acryloyloxybutylphenyldlmethoxysilane can be used. In this invention, “(meta) acrylate” means “acrylate or ethacrylate.”

Other polymerizable unsaturated monomer (M-2)

Other polymerizable unsaturated monomers (M-2) which can be used in the present invention are those which can copolymerize with an alkoxysilyl group in the unsaturated monomer (M-1).

Examples of such polymerizable monomers include those having a cationic reaction functional group comprising a polymerization unsaturation monomer like an epoxy function comprising polymerizable unsaturated monomer such as a glycidyl (meth)acrylate, 3,4-epoxy cyclohexyl (meth)acrylate, α,β-methyl glycidyl (meth)acrylate, allyl glycidyl ethene-octene ring comprising unsaturated ethylene monomer such as 3-ethyl-3-methacryloyloxy methyloxetan, 3-methyl-3-methacryloyloxy methyloxetan, 3-butyl-3-methacryloyloxy methyloxetan, all of which can be used as monomer (M-2).

Furthermore, other polymerization unsaturation monomers (M-2) that can be used include, for example, carbon number 1-24 alkyl group alkyl (meth) acrylates of linear, branched or cyclic, such as methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, 2-ethylhexyl (meth)acrylate, n-octyl (meth)acrylate, laurate (meth)acrylate, tridecyl (meth)acrylate, stearyl (meth)acrylate, cyclo hexyl (meth)acrylate, isobornyl (meth) acrylate, tri cyclo decane (meth) acrylate, di cyclo, pentenyl (meth) acrylate, di cyclo pentenyl oxy ethyl (meth) acrylate; branched or circular alkyl (meth) acrylate; mono esterification compounds with (meta) acrylic acid and polyalcohol like 2-hydroxyethyl (meth) acrylate, hydroxypropyl. (meth) acrylate, 2,3-dihydrox-butyl (meth) acrylate, 4-hydroxybutyl (meth) acrylate, polyalcohols; ring-opening polymerization reactant with the esterification and ε-capro lactone; vinyl aromatic compounds such as styrene, vinyltoluene, α-mothylstyrene acrylonitrile, methacrylonitrile, tricyclodecane (meth) acrylate, isobornyl (meth) acrylate, vinyl acetate, Veova monomer (made by SHELL CHEMICALS CO., LTD.).

Still other polymerizable unsaturated monomers (M-2) that can be used include, for example, (meta)carboxyl group comprising polymerizable unsaturated monomers such as acrylic acid, maleic acid, maleic anhydride; N,N dimethylaminoethyl (meth) acrylamide, N,N-die thylaminoethyl (meth) acrylamide, N,N-dimethylaminopropyl (meth) acrylamide, N-methylolacrylamidemethyl ether, acrylamide of N-methylolacrylamidebutylether or its derivatives; (meth)acrylonitrile, styrene, vinyl acetate, piperidinyl comprising (meth) acrylate (for example, Hitachi chemical conversion company, brand name, “FA-711MM”, FA-712HM), fluorine containing alkyl (meth) acrylates, siloxane containing (meth) acrylates, and monomers having isocyanate groups.

The above polymerizable unsaturated monomers can be used alone or in combination with one or more such monomers.

In particular, the mix proportion rate of metallic complex of catalytic chain transfer agent is not limited when producing ethylenically unsaturated monomer with the CCTP polymerization method, but a preferred mixture comprises 1×10⁻⁶−1 parts by weight, preferably 1×10⁻⁴−1 parts by weight of the ethylenically unsaturated monomer. Within this range, 100 parts by weight is particularly preferred.

In addition, known coordination compounds can be combined as needed in order to improve adjustment and solubility of reactivity of metallic complex. For example, possible coordination compounds that can be used include pyridine, amine compounds such as, for example, tributyl amine or triphenylphosphine, and phosphorus compounds such as tributylphosphine. Other coordination compounds that can be used include triphenyl phosphine and tributyl phosphine, and amine compounds such as dyridine tributyl phosphine.

In addition, when producing the Oligomer by CCTP method, known radical polymerization initiators can be used. Representative polymerization initiators include peroxide type polymerization initiators such as cyclohexanone peroxide, 3,3,5-trimethylcyclohexanone peroxide, methylcyclohexanone peroxide, 1,1-bis(tert-butyl peroxyl)-3,3,5-trimethylcyclohexane, 1,1-bis(tert-butyl peroxyl) cyclohexane, n-butyl-4 4-bis(tert-butyl peroxyl) valate, cumenehydroperoxide, 2,5dimethylhexane-2 5-dihydroperoxide, 1,3-bis(tert-butyl peroxyl-m-isopropyl) benzene, 2,5dimethyl-2 5-di(tert-butyl peroxyl) hexane, diisopropylbenzeneperoxide, tert-butyl cumyl peroxide, decanoyl peroxide, lauroyl peroxide, benzoyl peroxide, 2,4dichlorobenzoyl peroxide, bis (tert-buiylcyclohexyl) peroxyl dicarbonate, tert-butyl peroxyl benzoate, 2,5-dimethyl-2 5-di (benzoyl peroxyl) bexane; Azo initiators such as 2,2′-azobis(iso butyronitrile), 1,1 -azobis(cyclohexane-1-carbonitrile), azo cumene, 2,2′-azobis methyl valero nitrile, 4,4′-azobis(4cyano valeric acid), 2-(tert-butyl azo)-2-cyano propane, 2,2′-azobis(2,4,4-tri-methylpentane), and dimethyl-2,2 azobis(2-methyl proplonate).

The mixing proportions of the radical polymerization initiator are not particularly limited, but it is preferred that the mix comprise about 0.1-20 parts by weight, preferably about 0.5-10 parts by weight initiator per 100 parts by weight ethylenically unsaturated monomer. 100 parts by weight can be combined when the polymerization reaction by CCTP method uses an organic solvent.

Particularly, when an organic solvent is used in the polymerization reaction, a solvent which can do dissolve or disperse the ethylenically unsaturated monomer or oligomer can be used without limit. Examples of organic solvents that can be used include hydrocarbon type solvent such as heptane, toluene, xylene, octane, and mineral spirits; ketones such as ethyl acetate, acetic acid n-butyl, isobutyl acetate, ethylene glycol monomethyl ether acetate, ester solvent of ethylene glycol monobutyl ether acetate, butanone, methylisobutyl ketone, diisobutyl ketone, cyclohexanone; alcohols such as methanol, ethanol, isopropanol, n-butanol, sec-butanol, isobutanoethers solvent such as n-butyl ether, dioxane, ethylene glycol monomethyl ether aromatic petroleum type solvents such as Swasol 310, Swasol 1000, Swasol 1500 (each of the Swasol products made by COSMO OIL COMPANY LIMITED).

These organic solvents can be used alone or in any combination of two or more. A mix proportion ratio of organic solvent of less than 400 parts by weight based on a total 100 weight parts by weight of polymerization unsaturation monomer is preferred.

In addition, other solvents that can be used include a mixture of epoxy compounds and compounds having alkoxysilyl groups, which can produce a composition of the high solid which does not contain organic solvent (100% solid content).

Using the CCTP method, copolymerization can be done by heat in organic solvent in the presence of metallic complex and radical initiator with the monomer component.

This copolymerization reaction can use the following method to control temperature rise in the course of the polymerization reaction. A metallic complex and organic solvent are combined in a reaction vessel, subsequently allowed to increase to a temperature of 60-200° C., while subsequently stirring, and slowly adding ethylenically unsaturation monomer and Radical polymerization with required time. In this method, one part of metallic complex or all along with ethylenically unsaturated monomer can drip.

As the CCTP resin (A), the polymer that a polymerization does polymerization unsaturation monomer in the presence of Oligomer having ethylenically unsaturated group produced by CCTP method, and polymer (a-2) can be used in addition to the Oligomer (a-1). Oligomers that can be used with the polymer (a-2), include those that can be used with the Oligomer (a-1). Furthermore, other Oligomers (a-1) that can be used include Oligomers consisting of the other polymerization unsaturation monomer which do not contain cationic reaction group comprising polymerization unsaturation monomer (M-1) as ethylenically unsaturated monomer (M-2).

Polymerization unsaturated monomers that can be used with the polymer (a-2) include at least one kind of monomer selected out of alkokysilyl group comprising polymerization unsaturation monomer (M-1) and other polymerization unsaturation monomer (M-2).

Alkoxysilyl group comprising polymerization unsaturation monomer (M-1) is not always a requirement as polymerization unsaturation monomer in cases having an alkoxysilyl group as the Oligomer (a-1). When the Oligomer (a-1) does not have an alkoxysilyl group, alkoxysilyl group comprising polymerization unsaturation monomer (M-1) as polymerization unsaturation monomer should be used.

The polymer (a-2) can be produced by radical polymerization reactions with at least one kind of monomer selected out of monomer (M-1) and monomer (M-2) in Oligomer (a-1). Production of the polymer (a-2) can also be accomplished by polymerization reaction of polymerization unsaturation monomer in Oligomer, polymerization initiator and liquid mixture of organic solvent.

In the present invention, cationic reaction compound (B) can be a compound having a cationic reaction group. Preferred members of this group consist of, for example, compounds having epoxy functionality, oxetane ring group, alkoxysilyl group, hydroxyl group, carboxyl group, acid anhydrous group, vinyl ether group, in one molecule. For example, the cationic reaction compound can include those having epoxy functionality, alkoxysilyl groups, hydroxyl groups, carboxyl groups, acid anhydrides, vinyl ether groups, and oxetane groups.

Examples of compounds having epoxy functionality that can be used include, ethyleneglycol diglycidylether, polyethylene glycol diglycidyl ether, propylene glycol diglycidyl ether, tripropylene glycol diglycidyl ether, polypropylene glycol dliglycidyl ether, 1,4-butanediol diglycidyl, ether, neopentyl glycol diglycidyl ether, 1,6-hexanedioldiglycidylether, glycerin diglycidyl ether, diglyceroltetraglycidylether, trimethylolpropane triglycidyl ether, 2,6-diglycidy phenyl ether, sorbitol tri glycidyl ether, tri glycidyl isocyanurate, diglycidyl amine, diglycidyl benzylamine, diphtalate glycidyl ester, bisphenol-A diglycidyl ether, butadiene oxide, DCPDdioxide,diester with 3,4-epoxy cyclohexenecarboxylic acid and ethyleneglycol,3,4-epoxycyclohexybnethyl-3,4-epoxycyclohexane carboxylate, 3,4-epoxy-6-methyleyelohexyl methyl-3 4-epoxy-6methyleyclohexane carboxylate, appendage with bis(3,4-epoxy cyclohexylmethyl) adipic acid ester, dicyclopentadiene oar epoxide glycidyl ether, dipentene dioxide, bisphenol A type epoxide resin and ethylene oxide, EPOL EAD GT300 (Daicel Chemical Industries, Ltd., 3 function alicycle type epoxy compounds), F GT400 Waicel Chemical Industries, Ltd., tetra-functional alicyclic type epoxy compounds); GT301, GT302, GT303 (Daicel Chemical Industries, Ltd., decyclization ε-capro lactone chain comprising tri-functional alicycle type epoxy compounds); GT401, GT402, GT403 (Daicel Chemical Industries, Ltd., decyclization ε-capro lactone chain comprising tetra-functional alicyclic epoxy compounds), Celoxide 2021 P (Daicel Chemical Industries, Ltd.); Epikote 828, Epikote 834, Epikote 1001 (Yuka Shell Epoxy Co., Ltd., bisphenol A type epoxide resin); Epikote 154 (Yuka Shell Epoxy Co., Ltd. creosol Novolak type epoxide resin), Celoxide 2081 expressed with the following formula (1): Celoxide 2082, Celoxide 2083 (Daicel Chemical Industries, Ltd—In the following formula (1): Celoxide 2081 is n=1, Celoxide 2082 is n=2 and Celoxide 2083 is n=3); EX-411 expressed with the following formula (2) (Nagase Brothers chemical conversion Co., Ltd.).

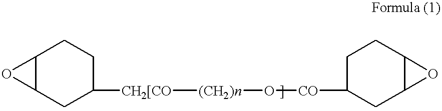

In formula (1), n is an integer of 1-3.

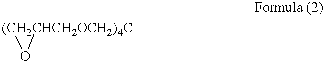

The epoxy functional compound can be used alone or in combination with others. The epoxy content of the epoxy functional compound can be from about 100 to more than 3,000, with the range of about from 100 to more than 1,500 being preferred.

The alkoxysilyl group comprising compound can be a compound containing more than two alkokysilyl groups in each molecule. Examples of compounds containing alkoxysilyl groups that can be used in the present invention include dimethoxy dimethyl silane, dimethoxy diethyl silane, dimethoxy diphenyl silane, diethoxy dimethyl silane, trimethoxy methyl silane, trimethoxy ethyl silane, trimethoxy propyl silane, trimethoxyphenyl silane, tetramethoxy silane, tetraethoxy silane, tetra butoxy silane, the alkoxy orchid which do not have polymerization nature unsaturated group of dimetboxy diethoxy silane,-γ-glycide oxy propyl trimethoxy silane, β-(3,4epoxy cyclohexyl) ethyl trimethoxy silane,-γ-glycide oxy propyl methyl. dietboxy silane, γ-glycide oxy triethoxy silane, γ-(meta) acryloxy propyl trimethoxy silane,-γ-(meta) acryloxy propyl. methyl diethoxy silane,-γ-(meta) acryloxy propyl triethoxy silane.

Examples of the acid anhydride (sometimes referred to as “polyacid anhydride”) that can be used in the present invention include an anhydrous pyromerit acid condensate [etbylenebis(An hydro trimelli tate)] with ethylene glycol 1 mol and anhydrous trimeritacid 2 mol, Condensate [glycerin tris (An hydro trimelli tate)] with glycerin 1 mol and anhydrous trimerit acid 3 mol; the linear that polybasic acid did intermolecular condensation or cyclic polyacid anhydride such as succinic acid adipic acid, azelaic acid, sebacic acid, dodecane diacid, dimer acid, ethyl-octadecane diacid, phenyl-hexadecane diacid, 1,4-cyclohexanedicarboxylic acid; polymerization unsaturated acid anhydride monomer component and polymer such as maleic anhydride, tetrahydrophthalic anhydride.

Examples of a monomer of polymerization unsaturated acid anhydride which can produce the polymer include, for example, alkyl (meth) acrylates of C1-24 such as methyl (meth) acrylate, ethyl (meth) acrylate, n-propyl (meth) acrylate, isopropyl (meth) acrylate, n-butyl (meth) acrylate, isobutyl (meth) acrylate, tert-butyl (meth) acrylate, 2-ethylhexyl acrylate, nonyl (meth) acrylate, laurate (meth) acrylate, tridecyl (meth) acrylate, stearyl (meth)acrylate; polymerizable unsaturated monocarboxylic acids such as acrylic acid, methacrylic acid, crotonic acid; vinyl aromatic compounds such as styrene, vinyl toluene, α-methyl styrene; acrylonitrile, methacrylonitrile, tri cyclo decanyl (meth) acrylate, isobornyl (meth) acrylate, vinyl acetate, Veova monomer (made by SHELL CHEMICALS CO., LTD.). Copolymerization reaction of these monomers can be carried our using a catalytic chain transfer polymerization with a cobalt complex.

Cationic polymerization initiators that can be used according to the present invention include compounds that initiate cationic polymerization reaction by light, heat, laser, and electron beams. Preferred examples of such compounds include diazonium salt, iodonium salt, sulfonium salt, phosphonium salt, selenium salt, oxonium salt, ammonium salt. Commercially available examples of cationic compounds that can be used include C I -2921, CI-2920, CI-2946, CI-3128, CI-2624, CI-2639, CI-2064 (Nippon Soda Co. Ltd., company product, a brand name), CP-66, CP-77 (Asahi Denka Kogyo company product, a brand name), PC-520 OM company product, a brand name). These can be used to generate cationic polymerization initiators by heat.

Examples of a cationic polymerization initiator generated by light or actinic radiation include the following preferred commercially available products: Cyracure UV 1-6970, Cyracure 1.1 VI-6974, Cyracure UVI-6990, Cyracure UVI-6950 (U.S.A. UNION CARBIDE CORP. company, brand name), Irgacure 261 (Ciba Specialty chemical company, brand name), S P-150, S P-170 Wahl Denka Kogyo K. K-, brand name), CG-24-61 (Caba Specialty Chemical Company, brand name), DAICAT II (DAICEL CHEMICAL INDUSTRIES, LTD. company, brand name WVAC 1591 (Daicel U.C.B company Co., Ltd, brand name), G1-2734, C1-2865, C1-2823, C1-2758 (Nippon Soda company product, a brand name), PI-2074 (Rhone Poulene company, brand name, pentafluorophenyl borate toluyl cumyl iodonium salt), F F C 509 (3M company product, a brand name), B B1-102, 13B1-101 (Midon-chemistry company, brand name), CD-1012 (U.S.A, Sartomer company, brand name).

Examples of radical polymerization initiators that can be used with the present invention include those that are well known. Examples of heat curable radical polymerization initiator compounds that can be used include, polymerization initiator of azo for example, as azobisisobutyro nitrile, compounds of a peroxide type for example, isobutyryl peroxide, a, a bis(neo-decanoyl peroxyl) diisopropyl benzene, cumyl peroxylneodecanate, di-n-propyl peroxyl di carbonate, di-sec-butyl peroxyl di carbonate, 1,1,3,3 tetra methyl butyl peroxyl neodecanate,-bis(4butylcyclohexyl) peroxyl di carbonate, 1-cyclohexyl-methyl ethyl peroxyl neo decanate, di-2 ethoxy ethyl peroxyl dicarbonate, di (2-ethylhexyl peroxyl) di carbonate, t-hexyl peroxyl neodeca nate,I)i (3-methyl -3-methoxybutyl peroxyl) di carbonate, tbutyl peroxyl neodeca nate, t-hexyl peroxyl pivalate, t-butyl peroxyl pivalate, 3,5,6-trimethyl hexanoylperoxide, octa nonyl peroxide, lauroyl peroxide, stearoyl peroxide, 1,1,3,3-tetramethylbutyl peroxyl2-othyl hexanoate, succinyl peroxide, 2,5-dimethyl-2 5-di (2-ethyl hexanoyl peroxyl) hexane, 1-cyclohexyl-I-methylethyl peroxyl, -2-ethyl hexanoate,thexyl peroxyl 2-ethyl hexanoate, 4-methyl benzoyl peroxide, t-butyl peroxyl 2-ethyl hexanoate, m-toluoyl and benzoyl peroxide,benzoyl peroxide, 1,1-bis(t-butyl peroxyl) 2-methylcyclohexane, 1,1-bis(t-hexyl peroxyl)-3,3,5-trimethylcyclohexane, 1,1-bis(thexyl peroxyl) cyclohexane, 1,1-bis(t-butyl peroxyl)-3,3,5-trimethyleyclohexane, 1,1-bis˜tbutyl peroxyl) cyclohexane, 2,2-bis(4,4-dibutyl peroxyl cyclohexyl) propane, 1,lbis(t-butyl peroxyl) cyclodecane,t-hexyl peroxyl isopropyl mono carbonate, t-butyl peroxyl maleic acid, tbutyl peroxyl-3,5,5-trimethylhexanoate, a t-butyl peroxyl laurate, 2,5-dimethyl-2 5-di. (m-toluoyl peroxyl) hexane, tbutyl peroxyl isopropyl mono carbonate, t-butyl peroxyl 2-ethylhexyl mono carbonate, t-hexyl peroxyl benzoate, 2,5-dimethyl-2,5-di (benzoyl peroxyl) hexane,t-butyl peroxyl acetate, 2,2-bis(tbutyl peroxyl) butane, t-butyl peroxyl benzoate, n-butyl-4 4-bis(t-butyl peroxyl) valate, di-tbutyl peroxyl iso phthalate, a, a ′bis(t-butyl peroxyl) di iso propyl benzene, di cumyl peroxide, 2,5dimethyl-2 5-di (t-butyl peroxyl) hexane, t-butyl cumyl peroxide, di-tbutyl peroxide, P menthane hydro peroxide, 2,5 dimethyl-2 5-di (t-butyl peroxyl) hexyl-3, diisopropyl benzene hydro peroxide, t-butyl trimethylsilyl peroxide, 1,1,3,3-tetramethylbutyl hydro peroxide, cumene hydro peroxide, t-hexyl hydro peroxide, tbutyl hydro peroxide, 2,3-di-methyl-2,3-diphdnylbutan.

Examples of light curable radical polymerization initiators that can be used include, for example, 2,4 trichloromethyl-(4′-methoxyphenyl)-6-triazine, 2,4-trichloromethyl -(4′-methoxy naphthyl)-6-triazine, 2,4-trichloromethyl-(piperonyl)-6 triazine, 2,4-trichloromethyl-(4′-methoxy styryl)-6-triazine,2-[2-(5-methylfuran-2-yl) ethenyl]-46-bis(trichloromethyl)-S-triazine, 2[2-(furan-2-yl) ethenyl]-4 6-bis(trichloromethyl) -S-triazine, Triazine-type compound such as 2-[2-(4-dimethylamino-2 methylphenyl) ethenyl]-4 6-bis(trichloromethyl)-S-triazine, 2[-2 dimethylaminoethyl) amino]-4 6-bis (trichloromethyl)-S-triazine, 2[2-(3,4-dimethoxyphenyl) ethenyl]-4 6-bis (tiichloromethyl)-S-triazine, 2-(4-methoxyphenyl)-4 6-bis(trichloromethyl)-S-triazine, 2methyl-4 6-bis(trichloromethyl)-S-triazine, 2,4,6-tris(trichloromethyl)-S-triazine, tris (chloromethyl) triazine,Acetophonone type compound such as 4phenoxy dichloroacetophenone, 4-tert-butyl-di-chloroacetophenone, 4-tert-butyl-trichloroacetophenone, diethoxy acetophenone, 2-hydroxy-2methyl-1-phenylpropane-I-on, 1(4-isopropylphenyl)-2-hydroxy-2methylpropane-1-on, 1-(4-dodecyl phenyl)-2-hydroxy-2methylpropane-1-on, 4-(2-hydroxyphenoxy)-phenyl (2-hydroxy-2-propyl) ketone, Ihydroxycyclohexyl phenyl ketone, 2-methyl-1-1 4-(methylthio) phenyl-2-morphohno propane-1, thioxanthone type compounds such as thi-oxanthone, 2-chloro thioxanthone, 2-methylthio xanthone, 2,4-dimethyl thioxanthone, 2,4-diethyl thioxanthone, isopropylthio xanthone, 2,4 dichloro thioxanthone, Benzoin, benzoin type compound of benzoin methyl ether, dimethylbenzyl ketal, acyl phosphine oxide.

Examples of the acyl phospho oxides that can be used include Lucirin T P 0 (BASF AG, brand name), Irgacure 1700, Irgacure 149, Irgacure 1800, Irgacure 1850, Irgacure 819 (Ciba Specialty chemical company, brand name).

Examples of radical reactivity compounds that can be used with the present invention include acryl type compounds having a molecular weight or about from 190 to more than 10,000, preferably about from 250 to about 2,000. It is also preferred to have at least one (meta) acryloyl group in each molecule. When the molecular weight of the radical reactivity compound is less than about 190, the vaporization rate is too high and the resulting odor is too strong, in addition to a resulting reduction in the quality of the coating. In contrast, with molecular weight of more than 10,000, workability is inferior and application is difficult because the viscosity becomes too high.

Other radical reactivity compounds that can be used include phenolpolyethoxylate (meta)acrylate,phenolpoly propoxy (meta) acrylate, nonylphenol mono ethoxylate acrylate, 2-ethylhexyl carbitol acrylate, para cumyl phenol ethylene oxidede modefy(meta)acrylate, isobornyl (meta) acrylate, diethylene glycol di (meta) acrylate, triethylene glycol di (meta) acrylate, propylene glycol di (meta) acrylate, dipropylene glycol di(meta)acrylate, tripropylene glycol di (meta) acrylate, polyethylene glycol di (meta) acrylate, polypropylene glycol di (meta) acrylate, butanediol di (meta) acrylate, hexane diol di(meta) acrylate, nonane diol di (meta) acrylate, neopentyl glycol di (meta) acrylate, tricyclo decane dimethylolcli(meta) acrylate, bisphenol F ethylene oxide modefy di (meta) acrylate, bisphenol , ethylene oxide modified (meta) acrylate, isocyanuric acidethyleneoxide modified (meta) acrylate, trimethylolpropane tri (meta) acrylate, trimethylolpropane di(meta) acrylate, glycerin di (meta) acrylate, glycerin tri(meta)acrylate, pentaerythritol tri (meta) acrylate, trimethylolpropane ethoxy tri (meta)acrylate, trimethylolpropane ethyleneoxide modified (ethylene oxide) tri (meta) acrylate, trimethylolpropane propoxy tri (meta) acrylate, trimethylolpropane PO (propylene oxide) modified tri (meta) acrylate, penta erythritol tetra (meta) acrylate, di tri methylol propane tetra (meta) acrylate, di pentaerythn-tol hexa (meta) acrylate, isocyanuric acid ethylene oxide modified tri acryrate, polyester di acrylate, bisphenol A-diepoxy acrylic acid appendage, acryl acrylate.

In the embodiments of the present invention described in Claims 1 and 2, the alkoxysilyl group comprising copolymer (A) can be 10-100 parts by weight, preferably 20-80 parts by weight. In those embodiments, the cationic reaction compound can be 0-90 parts by weight, preferably 20-80 parts by weight, and the cationic polymerization initiator can be 0.05-20 parts by weight, preferably 0.5-20 parts by weight. When the mix proportion ratio of component (A) is less than 10 parts by weight, film hardness is inferior. Similarly, when the mix proportion ratio of component (A) exceeds 100 parts by weight, film hardness is inferior. When the mix proportion ratio of component (C) is 0.05 parts by weight less than, curable is inferior. When the mix proportion ratio of component (C) exceeds 20 parts by weight, weather resistance is inferior.

In the embodiments of the present invention described in Claims 1 and 2, the alkoxysilyl group comprising copolymer (A) can be 10-99.5 parts by weight, preferably 20-80 parts by weight, and radical reactivity compound can be 0.5-90 parts by weight, preferably 20-70 parts by weight and the cationic polymerization initiator can be 0.05-20 parts by weight, preferably 0.5-1 0 parts by weight and radical polymerization initiator can be 0.05-20 parts by weight, preferably 0.5-10 parts by weight. When the mix proportion ratio of component (A) is 10 parts by weight less than, film hardness is inferior. When a mix proportion ratio of component (A) exceeds 99.6 parts by weight, film hardness is inferior. When the mix proportion ratio of radical reactivity compound is less than 0.5 parts by weight, hardness of the film inside is inferior. When a mix proportion ratio of radical reactivity compound exceeds 90 parts by weight, surface hardness of a film is inferior. When the mix proportion ratio of cationic polymerization initiator is 0.05 parts by weight less than, curability is inferior, and when the mix proportion ratio exceeds 20-parts by weight, weather resistance of the film is inferior. Similarly, when the mix proportion ratio of radical polymerization initiator is less than 0.05 parts by weight, curability is inferior, and when the mix proportion ratio exceeds 20 parts by weight, weather resistance of the film is inferior.

In the embodiments of the present invention described in Claim 5, alkoxysilyl group comprising copolymer (A) can be 10-98 parts by weight preferably 20-80 parts by weight; cationic reaction compound can be 1-90 parts by weight, preferably 20-70 parts by weight; and radical reactivity compound can be 1-90 parts by weight, preferably 20-70 parts by weight; and cationic polymerization initiator can be 0-05-20 parts by weight, preferably 0.5-10 parts by weight and radical polymerization can be 0.05-20 parts by weight, preferably 0.5-10 parts by weight. When the mix proportion ratio of component (A) is less than 10 parts by weight, film hardness is inferior. When the mix proportion ratio of component (A) exceeds 98 parts by weight, film hardness is inferior. When the mix proportion ratio of component (B) is less than I part by weight, film hardness is inferior. When a mix proportion ratio of component (B) exceeds 90 parts by weight, film hardness is inferior. When the mix proportion ratio of component (E) is less than 1 part by weight less than, hardness of the film inside is inferior. When the mix proportion ratio of component (E) exceeds 90 parts by weight, surface hardness of a film is inferior. When the mix proportion ratio of component (C) is less than 0.06 parts by weight, curability is inferior, and when the mix proportion ratio of component (C) exceeds 20 parts by weight, weather resistance of the film is inferior and the price becomes high. When the mix proportion ratio of component (D) is less than 0.05 parts by weight, curability is inferior, and when the mix proportion ratio of component (D) exceeds 20 parts by weight, weather resistance of a film is inferior.

The compositions of the present invention composition can use organic solvents to dissolve or disperse the components of the coating composition. Examples of such solvents include, for example, hydrocarbon type solvents such as heptane, toluene, xylene, octane, mineral spirit; ester solvent such as ethyl acetate, acetic acid n-butyl, i-sobutyl acetate, ethylene glycol monomethyl ether acetate, diethylene glycol monobutyl ether acetate;ketones solvent such as acetone, butanone, methyl isobutyl ketone, diisobutyl ketone, cyclohexanone; alcohols solvent such as methanol, ethanol, isopropanol, n-butanol, sec-butanol, isobutanobether system such as n-butyl other, dioxane, ethylene glycol monomethyl ether, ethylene glycol monoethyl ether; aromatic petroleum type solvent such as Swasol 310, Swasol 1000, Swasol 1500 (made in COSMO OIL COMPANY LIMITED. company both), SHELLSOL A (made in Shellsol A, SHELL CHEMICALS CO., LTD. company). These organic solvents can be used alone or in combination.

The compositions of the present invention be combined, as needed with various conventional additives used in the preparation of coating compositons, including, for example, photosensitizer (for example, anthracene type compound, anthraquinone compound, fluoro olefinic type compounds, naphthalene type compounds, pyrene type compounds, fillers, colorants, pigments, pigment agent, fluid flow modifiers, leveling agents, defoaming agent, antifoaming agent, UV absorbers, light stabilizers, oxidation inhibitors, gel corpuscule, and corpuscle powder. Examples of pigments that can be used include inorganic color pigment such as titanium dioxide white, carbon black, red ocher, titanium yellow; organic color pigment such as quinacridon red, azo red, copper phthalocyanine blue, copper plithalocyanine green, an organic yellow pigment; colorpigment of luminosity nature pigments such as aluminium flake, luminosity nature mica powder, luminosity nature graphite; extender, Body pigment, filler such as silica powder, calcium carbonate, barium sulfate, mica, Clay, China clay, Talc, Magnesium silicate; rust preventive pigment such as calcium ion exchange silica, phosphate type rust preventive pigment, a chromate type pigment. An amount of mix proportion of a pigment can be used in a range which does not obstruct the curing reaction based on cationic and radical reaction by light exposure. Specifically, an amount of mix proportion of a pigment is less than 200 parts by weight, a preferably I100 parts by weight based on an amount of total 100 parts by weight of component of clear film.

A flowing property modifier can be used, including known flowing property modifier used in the field of coating. For example, silica-base impalpable powder, bentonite type modifier, polyamide type modifier, di urea type modifier, organic resin corpuscle produced by water system emulsion polymerization or nonaqua dispersion polymerization can be used. Of the inorganic resins that can be used, those being crosslinked and comprising fine particles are preferred.

The compositions of the present invention can be applied as coating materials to a substrate or base material such as metal, kettle, plastic, paper, wood materials, inorganic materials, electro-coating panel, laminate panel, film of PET and combination of the above. For example, the application method can be a known or conventional one including spray coating, roll coating, gravure coating, coater coating, silk screen printing, spin coating, flow coating, and electrostatic coating.

A coating film formed according to the method of the present invention and cured after application should have a thickness of about 0.5-100 μm (a Drying film thickness), following heat or activity energy rays irradiation, or heat after having irradiated.

For the heat curing step of the process of the present invention, it is preferred that the temperature be about 40° C.-260° C., and preferably about 70° C.-200° C. Heating can be accomplished by exposing the coated substrate to heat generated in an oven, infrared light rays, induction heating and dielectric heating.

Examples of actinic radiation for curing the compositions of the present invention can include an actinic energy ray using low-pressure mercury lamp, a medium pressure mercury lamp, high pressure mercury vapor lamp, ultrahigh pressure mercury lamp, incandescent lamp, Xenon arc lamp, carbon arc light, metal halide lamp, fluorescent lamp, tungsten lamp, gallium lamp, excimer, laser, electron beam, beta ray, gamma ray and sun light.

### EXAMPLES

The present invention will be explained more in detail by the following Examples, in which “part” and ‘V’represent “part by weight” and “% by weight” respectively.

Production Example 1

68.3 parts toluene is combined with the reaction apparatus having installed agitator, cooler, temperature controls, nitrogen introduction tube and a drip hopper, subsequently air in reaction vessel was substituted for nitrogen, and was heated by 105° C.

Subsequently a mixture of KBM-503 (alkoxysilyl group comprising methacrylate monomer made in Shin-Etsu Chemical Co., Ltd. company, following similar) 100 parts, azobisisobutyronitrile 2 parts and 0.01 parts bis(boron difluoro dimethylglyoximate) cobalt (II) was added by dropping in the toluene over a period of three hours. After the drip end, aging with 105° C. for 30 minutes, drip liquid mixture of 11 parts of toluene and 0.5 parts azobisisobutyronitrile for one hour. After having held in 105° C. for 30 minutes, toluene was removed with reduced pressure, and alkoxysilyl group comprising Oligomer A-1 was produced.

The resin so produced was liquid, and exhibited a weight average molecular weight about 1230 Gardner Viscosity G, number average molecular weight about 740.

Production example 2

68.3 parts KBM-303 (3.4-epoxy cyclohexyl) ethyl trimethoxysilane made in Shin-Etsu Chemical Co., Ltd. company, following similar) is combined with the reaction apparatus which installed agitator, cooler, temperature controls, a nitrogen introduction tube and a drip hopper,

subsequently air in reaction vessel was substituted for nitrogen, and was heated by 105° C. Subsequently mixture of KBM-503 (alkoxysilyl group comprising methacrylate monomer made in Shin-Etsu Chemical Co., Ltd. company, following similar) 100 parts, azobisisobutyronitrile 2 parts and 0.01 parts bis(boron difluoro dimethylglyoximate) cobalt (II) drop in the toluene for 3 hours. After the drip end, aging with 105° C., for 30 minutes, drip liquid mixture of 11 parts of toluene and 0.5 parts azobisisobutyronitrile for 1 hour. After having held in 105° C. for 30 minutes, toluene was removed with reduced pressure, and alkoxysilyl group comprising Oligomer A-2 is produced. Produced resin liquid A-2, weight ratio of pitch and KBM-303 is 55 to 45.

Produced resin was liquid, and exhibited a weight average molecular weight about 1210 Gardner Viscosity B, number average molecular weight about 730.

Production example 3

68.3 parts toluene is combined with the reaction apparatus which installed agitator, cooler, temperature controls, a nitrogen introduction tube and a drip hopper, subsequently air in reaction vessel was substituted for nitrogen, and was heated by 105

Subsequently mixture of KBM-503 Part 80, GK-100 (alicycle type epoxy function comprising methacrylate made in Daicel company, a brand name) 20 parts azobisisobutyronitrile 2 parts and 0.01 parts bis(boron difluoro dimethylglyoximate) cobalt (11) drop in the toluene for 3 hours.

After the drip end, aging with 105 r, for 30 minutes, drip liquid mixture of 11 parts of toluene and 0.5 parts azoblisisobutyronitrile for 1 hour, After having hold in 105*C for 30 minutes, toluene was removed with reduced pressure, and alkoxyl group comprising Oligomer A-3 was produced.

Produced resin was liquid, and was found to have a weight average molecular weight about 1180, Gardner Viscosity G, and number average molecular weight of about 690.

Production example 4

68.3 parts toluene is combined with the reaction apparatus which installed agitator, cooler, temperature controls, a nitrogen introduction tube and a drip hopper, subsequently air in reaction vessel was substituted for nitrogen, and was heated by 105° C. Subsequently mixture of KBM-503 60 Part, 3-ethyl-3-methacryloyloxy-methyl oxetane (oxetane group comprising methacrylate made in Ube Industries company) 20 parts, glycidyl metbacrylate 20 parts, azobisisobutyronitrile 2 parts and 0.01 parts bis(boron difluoro dimethylglyoximate) cobalt (II) drop in the toluene for 3 hours. After the drip end, aging with 105° C. for 30 minutes, drip liquid mixture of 11 parts of toluene and 0.5 parts azobisisobutyronitrile for 1 hour. After having held in 105° C. for 30 minutes, toluene was removed with reduced pressure, and alkoxyl group comprising Oligomer A-4 was produced.

Produced resin was liquid, and weight average molecular weight about 1310 Gardner Viscosity H, number average molecular weight about 760.

Production example 5

Alkoxysilyl group comprising resin A-1 70 parts produced with production example 1, toluene 69.7 parts is combined with the reaction apparatus which installed agitator, cooler, temperature controls, a nitrogen introduction tube and a drip hopper, subsequently air in reaction vessel was substituted for nitrogen, and was heated by 105° C. Subsequently mixture of isobornyl acrylates 30 parts, azobisisobutyronitrile 2 parts and 0.01 parts bis (boron difluoro dimethylglyoximate) cobalt (II) drop in the toluene for 3 hours. After the drip end, aging with 105° C. for 30 minutes, drip liquid mixture of 11 parts of toluene and 0.5 parts azobisisobutyronltrile for 1 hour. After having held in 105° C. for 30 minutes toluene was removed with reduced pressure, and alkoxysilyl group comprising Oligomer A-5 was produced.

The resin produced was liquid, and exhibited a weight average molecular weight of about 1820, Gardner Viscosity S, and number average molecular weight about 1070.

Production example 6

Alkoxysilyl group comprising resin A-1 (30 parts) produced with production example 1, toluene 68.9 parts is combined with the reaction apparatus which installed agitator, cooler, temperature controls, a nitrogen introduction tube and a drip hopper. Subsequently air in reaction vessel was substituted for nitrogen, and was heated by 105° C. Subsequently drip mixture of GK-100 (40 parts), azobisisobutyronitrile (2 parts) for 1.5 hours. Subsequently drip KBM-503 30 part, a mixture consisting of 0.6 parts azobisisobutyronitrile could be dripped for 1 hour. After the drip end, aging with 105° C for 30 minutes, drip liquid mixture of 11 parts of toluene and 0.5 parts azobisisobutyronitrile for 1 hour. After having held in 105° C. for 30 minutes, toluene was removed with reduced pressure, and alkoxysilyl group comprising Oligomer A-6 was produced.

The resulting resin was liquid, and exhibited a weight average molecular weight about 2300 Gardner Viscosity Z, number average molecular weight about 3700.

Production example 7

Toluene 68.9 parts is combined with the reaction apparatus which installed agitator, cooler, temperature controls, a nitrogen introduction tube and a drip hopper, subsequently air in reaction vessel was substituted for nitrogen, and was heated by 105° C. Subsequently drip mixture of resin A (1 70 parts) produced by production example 1, GK-200 (alicyclic type epoxy function comprising acrylate Daicel Chemistry Company, brand name, following similar procedures) (30 parts), azobisisobutyroni-trile (2 parts) for 3 hours. After the drip end, aging with 105° C. for 30 minutes, drip liquid mixture of 11 parts of toluene and 0.5 parts azobisisobutyronitrile for 1 hour, Continue after having held in 105° C for 30 minutes, toluene was removed with reduced pressure, and alkoxysilyl group comprising Oligomer A-7 was produced.

The resulting resin was liquid, and exhibited a weight average molecular weight about 2200, Gardner Viscosity T, and a number average molecular weight about 1300.

Comparison production example 1

Except for the lack of use of cobalt complex, this example was produced in the same manner as Production Example 1, and resin A-8 was produced.

Produced resin was solid, and the Gardner Viscosity was not able to measure. Produced resin was weight average molecular about 18000 and number average molecular weight about 9000.

Comparison production example 2

Except for the use of 20 parts of mercaptoethanol instead of the cobalt complex, this example was produced in the same manner as Production Example 1, and resin A-9 was produced.

The resulting resin exhibited a weight average molecular of about 2900, a Gardner Viscosity T, a number average molecular weight about 1500 and a liquid of mercaptan aroma.

Comparison production example 3

In production example 5, using of alkoxysilyl group comprising resin A-9 produced with comparison production example 2 instead of alkoxysilyl group comprising resin A-1 produced with production example 1 except did a polymerization of an isobornyl acrylate same as production example 5.

In the more details, toluene 69.7 parts, alkoxysilyl group comprising resin A-9 produced with comparison production example 2 70 parts is combined with the reaction apparatus which installed agitator, cooler, temperature controls, a nitrogen introduction tube and a drip hopper, subsequently air in reaction vessel was substituted for nitrogen, and was heated by 105° C. Subsequently drip mixture of isobornyl acrylate 30 part, azobisisobutyronitrile 0.6 parts for 2 hours. After the drip end, aging with 105° C. for 30 minutes, drip liquid mixture of 11 parts of toluene and 0.5 parts azobisisobutyronitrile for 1 hour, After having held in 105 r- for 30 minutes, Continue toluene was removed with reduced pressure.

The produced resin produced cloudiness so that Compatibility was bad.

Production example 8

Radical polymerization reacted 500 parts of styrene, γ-methcryloxy propyl tri methoxy silane 500 Part, toluene 1000 parts, azobis dimethyl valero nitrile 80 parts with about 100° C. for 6 hours, and weight average molecular weight 3,500, resin varnish of production example 8 of solid 50% were produced.

### Example 1

A curable composition of example 1 was produced by combining 100 parts of Oligomer A-1 produced with production example 1, SANAID SI-60L (Sanshin Chemical Ind. company product, a brand name) two parts.

The composition was painted on glass plate (film thickness 15 μm), and subsequently heat cured at 130° C., for 30 minutes. Pencil hardness of a coating film was 5 H, and the adhesive property was good.

### Example 2

Oligomer A-1 (90 parts) produced with production example 1, EPIOL TMP-100 (it is made in Nippon Oil & Fats Co., Ltd. company, brand name) (10 parts), titanium dioxide (50 parts) were combined, and white enamel was produced. These 100 parts of white enamel, CI-2920 (Nippon Soda company, brand name, heat cationic catalyst) (4 parts) were doped, and a white enamel composition of example 2 was produced. This composition was painted (film thickness 20 μm) on steel plate of electro-coating, and heat cured at 140° C. for 20 minutes.

Pencil hardness of a coating film was 6H, and the adhesive property, the Acid resistance were good.

### Example 3

Oligomer A-1 (80 parts) produced with example 1, trimethylolpropane triacrylate 20 parts, UVAC 1591 (it is made in Daicel U.C.B company, brand name) (2 parts), Irgacure 184 (Ciba Specialty chemical company, brand name) (4 parts) were combined to produce a curable composition of example 3. The composition was coated to the surface urethane coating (film thickness 20 μm) film on iron plate, and cured by ultraviolet irradiation (600m J/cm²) with a metal halide lamp.

Pencil hardness of the resulting coating film was 6 H, and the adhesive property was good. The surface coating film showed no scratches after 10 back and forth stokes with steel wool.

### Example 4

Resin liquid A-2 (60 parts) produced with complex example 1, Aronix M350 (trimethylolpropane ethyleneoxide modyfy triacryrate, TOAGOSEI CHEMICAL INDUSTRY CO., LTD.) (40 parts), C1-2946 (Nippon Soda company, heat cationic polymerization initiator) 4 parts, per butyl Z (it is made in NIPPON OIL & FATS CO., LTD. company, brand name) (2 parts), UV absorber, Tinuvin 900 2 parts (Ciba Speciality Chemicals, brand name) were combined, and a curable composition of example 4 was produced. The composition Coated (film thickness 25 Am) on the panel painted electro-coating, Middlecoat coating, primer coating, finishing metallic, and heat cured at 130° C. for 30 minutes.

Pencil hardness of a coating film was 5 H, and the resistance steel wool abrasion was good. This coating panel was exposed in a sunshine wear-o-meter for 2000 hours. The panel exhibited good gloss retention of 95%.

### Example 5

Resin liquid A-2 (100 parts) produced with production example 2, C1-2758 (Nippon Soda company, brand name, cationic polymerization initiator) 2 parts were combined, and a curable composition of example 5 was produced. The composition was painted on glass plate to give a film thickness of 15 μm. The film was cured by ultraviolet irradiation (200m J/cm²) with metal halide lamp. The cured film was tested, and exhibited a pencil hardness of 8 H, and a Gel fraction ratio of 98%. The adhesion to the substrate and resistance to steel wool abrasion were good.

### Example 6

Resin liquid A-2 (80 parts) produced with production example 2, calcium carbonate 10 parts, titanium dioxide 40 parts, neopentylglycol diacrylate 20 parts were combined, and white enamel was produced. These 100 parts of white enamel, Cyracure UVI-6990 (Union Camp company, brand name) 4 parts, Irgacure 651 (Ciba Specialty Chemical K.K. brand name) (3 parts0 were combined, and a white enamel curing composition of example 6 was produced. This composition was coated at a film thickness of 8 μm onto a corona discharge treated PET film. The film was irradiated with ultra-violet rays of 500m J/CM² generated by a gallium lamp. Curing of the coating film was completed by heating at 100° C. for 10 minutes.

Adhesive properties of the coating film were good, and the Pencil hardness was 4 H.

### Example 7

Resin liquid A-2 (70 parts), tripropylene glycol diacrylate (30 parts) Sanaid SI-80L (2 parts) produced with production example 2, per butyl Z peroxide (NIPPON OIL & FATS CO., LTD. brand name) (two parts) were combined, and a curable composition of example 7 was produced. This composition was coated at a film thickness of 20 μm onto a polycarbonate panel. The film was subsequently cured by heating at 130° C. for 26 minutes. The film was tested and exhibited a pencil hardness of 6 H, good resistance to steel wool abrasion, and good adhesion to the substrate.

### Example 8

Oligomer A-8 (100 parts) produced with production example 3,4 parts of C1-2921 (Nippon Soda company, brand name, heat cationic catalyst), and a curing composition of example 8 was produced. This composition was coated at a film thickness of 2 μm onto an aluminum panel top which was painted with epoxy primer. The coating film was cured by heating at 110° C. for 30 minutes. The film was tested and exhibited a pencil hardness of 4 H, good resistance to steel wool abrasion, and good adhesion to the substrate.

### Example 9

Oligomer A-3 (80 parts) produced with production example 3, Aronix® M310 (TOAGOSEI CHEMICAL INDUSTRY CO., LTD.) (20 partso, C1-2758 (Nippon Soda company) (4 parts), Irgacure 184 (Ciba Specialty Chemical K.K., brand name) (4 parts) were combined, and a curable composition of example 9 was produced. This composition was coated at a film thickness of 5 μm onto polyvinyl chloride sheet. The resulting film was cured by ultraviolet irradiation (600m J/cm²) with metal halide lamp. The film was tested, and found to exhibit good adhesion to the substrate, and good resistance to steel wool abrasion.

### Example 10

Oligomer A-3 (100 parts) produced with production example 3, cyclohexyl divinyl ether (ten parts), bis(3-ethyl-3-methyl) ether (20 parts), UVAC 1591 (Daisel U.C.B. company, brand name) (3 parts) were combined, and an ultraviolet curing composition of example 10 was produced. This composition was coated at a thickness of 3 μm onto a polypropylene film treated with corona discharge. The resulting film was cured by ultraviolet irradiation (200m J/cm²) with a high pressure mercury vapor lamp. The resulting film was tested, and exhibited good adhesion to the substrate, and a pencil hardness of 3 H.

### Example 11

Oligomer A-4 (100 part) produced with production example 4, Sanaid 2021 P (Daicel Chemical Industry Co., Ltd.) (10 parts), xylylene dioxetane (10 parts), and CI-2946 (Nippon Soda company brand name) (4 parts), 1,4-di-p-toluenesulfonyl oxy cyclohexane (1 part) were combined, and a curing composition of example 11 was produced. This composition was coated at a film thickness of 20 μm onto a methyl methacrylate panel. the coating was cured by heating at 120° C. for 30 minutes. The resulting film was tested, and exhibited good adhesion to the substrate, and good resistance to steel wool abrasion.

### Example 12

Oligomer A-4 (100 parts) produced with production example 4, 1,6 hexanediol diacrylate (50 parts), trimethylolpropane triacrylate (20 parts), Celloxide 2021P (30 parts), titanium dioxide (50 parts), and copper phthalocyanine blue (1.5 parts) were combined, and blue enamel was produced. This blue enamel (100 parts), Sanaid SI-60L (Sanshin Chemical Ind. company Co., Ltd., brand name) (3 parts), Per Hexa C (NIPPON OIL & FATS CO., LTD. brand name, peroxide) (3 parts) were combined, and a curable composition of example 12 was produced. This composition was coated at a thickness of 20 μm onto a surface treated steel panel. The coating was cured by heating at 140° C. for 20 minutes. The resulting film was tested, and exhibited good adhesion to the substrate, and good resistance to steel wool abrasion. The Pencil hardness was 5H. The acid resistance and alkali resistance were good.

### Example 13

Oligomer A-4 (80 parts) provided with production example 4, Aronix(® M220 (TOAGOSEI CHEMICAL INDUSTRY CO., LTD., 2 di acrylate, brand name) (10 parts), γ-glycidyl oxy propyl tri methoxy silane (10 parts), CI-2758 (Nippon Soda company, cationic initiator, brand name) (2 parts), Irgacure 184 (Ciba Specialty company, brand name) (3 parts) were combined, and a curable composition of example 13 was produced.

The composition was painted onto glass plate to give a film thickness of 15 μm, and the resulting coating film was cured by heating at 180° C. for 15 minutes and irradiated by metal halide lamp with ultraviolet irradiation at 150m J/cm².

The resulting film was tested, and exhibited good adhesion to the substrate. The pencil hardness was 6H.

### Example 14

Oligomer A-5 (100 parts) produced with production example 5, Cyracure UVI-6990 (Union Carbide brand name) (3 parts), and a curing composition of example 14 was produced.

This composition was coated at a thickness of 6 μm onto a steel plate which was laminated with PET. The coating was cured by irradiating with a metal halide lamp at 200m J/cm².

The resulting film was tested, and exhibited good adhesion to the substrate. The pencil hardness was 3H.

### Example 15

Oligomer A-5 (100 parts) produced with production example 5, Viscoat 300 (OSAKA ORGANIC CHEMICAL INDUSTRY LTD., polyfunctional acrylate, brand name) (20 parts), G-100 (NIPPON OIL & FATS CO., LTD., brand name) (20 parts), 1,9-nonane diol diacrylate (25 parts), titanium dioxide (30 parts), and dioxide iron (5 parts) were combined, and a coloring enamel was produced. 100 parts of this coloring enamel, CI-2946 (Nippon Soda company, brand name) (3 parts), perbutyl Z (NIPPON OIL & FATS CO., LTD. company, brand name) (5 parts), 1,4-di-p-toluenesulfonyloxy cyclobexane (1 part) were combined, and a curing composition of example 15 was produced. This composition was applied at a thickness of 15 μm onto a primer treated aluminum sheet and plate. The resulting coating was cured by heating at 125° C. for 20 minutes.

The resulting film was tested, and exhibited good adhesion to the substrate. The pencil hardness was 5H.

### Example 16

Oligomer A-5 (100 parts) produced with production example 5, triethylene glycol divinyl ether (10 parts), y-glycidyl oxy propyl tri methoxy silane (20 parts), 3-ethyl-3-hydroxymethyl oxetane (ten parts), di C11-ethyl (3-methyl ether) (10 parts) were combined, and a clear composition was produced. The clear composition (100 parts), 1,4-di-p-toluenesulfonyl oxy cyclohexane (0.5 parts), and CI-2758 (Nippon Soda Co., Ltd., brand name) (4 parts) was combined to produce a curing composition of example 16. The composition was painted onto a glass plate to give a film thickness of 15 ,μm. The coating film was cured by heating at 120° C. for 10 minutes and treating with ultraviolet irradiation (300M J/cm²) from a metal halide lamp.

The resulting film was tested, and exhibited good adhesion to the substrate. The pencil hardness was 7H.

### Example 17

Oligomer A-6 (100 parts) produced with production example 6, UVAC 1591 Daicel company, brand name) (2 parts) were combined, and a cationic curable composition of example 17 was produced. The composition was painted onto a glass plate to give a film thickness of 15 μm. The coating film was cured by treating with ultraviolet irradiation (400M J/cm²) from a metal halide lamp.

The resulting film was tested, and exhibited good adhesion to the substrate. The pencil hardness was 5H.

### Example 18

100 parts of Oligomer A-6 produced from production example 6, titanium dioxide (50 parts), xylylene dioxetane (30 parts), and neopentyl glycol diacrylate (20 parts) were combined, and a white enamel was produced. This white enamel (200 parts), UVAC 1591 Daicel U.C.B.U. company, brand name) (4 parts), Irgacure 184 (5 parts), diethoxy anthracene (2 parts) were combined, and a curable composition of example 18 was produced. This composition was coated at a thickness of 5 μm onto an iron paaanel which was laminated on both sides with polyethylene terephthalate. The coating film was cured by treating with ultraviolet irradiation (400M J/cm²) from a metal halide lamp.

The resulting film was tested, and exhibited good adhesion to the substrate. The pencil hardness was 4H.

### Example 19

Oligomer A-6 (100 parts) produced with production example 6, di[l-ethyl (a 3-oxetanyl)] methyl ether (40 parts), Aronix M3 10 (TOAGOSEI CHEMICAL INDUSTRY CO., LTD., brand name) (10 parts), C1-2920 (Nippon Soda company, brand name) (5 parts), and Per Butyl Z (NIPPON OIL & FATS CO., LTD. company product, a brand name) (3 parts) were combined, and a curable composition of example 19 was produced. This composition was coated on a ceramic ware tile to give a film thickness of 20 μm. The film was cured by heating at 140° C. for 20 minutes.

The resulting film was tested, and exhibited good adhesion to the substrate. The mar resistance to steel wool abrasion was good.

### Example 20

1 part of UVAC 1591 (Daicel U.C.B company, brand name), Tinuvin 400 (Ciba Specialty chemical company, brand name) (2 parts) were combined with Oligomer A-7 100 part, C1-2758 (2 parts) produced with production example 7, to produce curable composition of example 20. The composition was coated onto an electro-coated panel having a primer coating, a middle coating, and a metallic topcoat, to provide a film thickness of 25 μm. The coating film was cured by ultra-violet radiation of I 000m J/cm².

The resulting film was tested, and exhibited good adhesion to the substrate. The pencil hardness was 5H.

### Example 21

Oligomer A-7 (100 parts) produced with production example 7, xylylene dioxetane (20 parts),-glycideoxypropyl trimethoxysilane (20 parts), and titanium dioxide (60 parts) were combined to produce a white enamel. This white enamel (100 parts), CI-3128 (Nippon Soda company, brand name) (4 parts0, Tinuvin (900 parts) were combined, and a curable composition of example 21 was produced. This composition was coated onto a glass plate at a thickness of 20 μm. The coating was cured by heating at 150° C. for 20 minutes.

The resulting film was tested, and exhibited good adhesion to the substrate. The pencil hardness was 6H.

Comparative Example 1

A coating of comparative example 1 was produced by the same method as example 1 using resin of comparison production example 1. The viscosity of the resulting coating was high, and the workability of the coating was inferior to that of Example 1.

Comparative Example 2

A coating of comparative example 2 was produced by the same method as Example 4, using resin of comparison production example 2. The resulting coating film produced yellowing, cracking, and choking by sunshine wear-o-meter at 400 hours and was generally inferior.

### Example 22

200 parts of resin produced in production example 8,1,6-hexanediol diacrylate (90 parts), Aronix 101 (TOAGOSEI CHEMICAL INDUSTRY CO., LTD., brand name) (10 parts), CI-2758 (Nippon Soda Co., Ltd., brand name) (6 parts), Irgacure 819 (Ciba Specialty chemical company, brand name) (10 parts) were combined, and a curable composition of Example 22 was produced. The composition was painted on glass plate to provide a film thickness of 15 μm. The film was cured by ultraviolet irradiation (400m J/cm²) with metal halide lamp. The coating film was cured by treating with ultraviolet irradiation (400M J/cm²) from a metal halide lamp.

The resulting film was tested, and exhibited good adhesion to the substrate. The mar resistance to steel wool abrasion was good.

I claim:

1. A curable coating composition comprising
(A) 10-100 parts by weight of a polymer containing an alkoxysilyl group having a weight average molecular weight of from about 500 to more than 10,000, and having at least one alkoxysilyl group in each molecule,
(B) 0-90 parts by weight of a cationic reactivity compound,
(C) 0.05-20 parts by weight of a cationic polymerization initiator.

2. A curable coating composition of claim 1 further comprising
(D) 0.5-90 parts by weight of a Radical reactivity compound,
(E) 0.05-20 parts by weight of a Radical polymerization initiator.

3. A curable coating composition of claim 1 wherein the polymer has a weight average molecular weight of about from 600 to 5,000.

4. A curable coating composition of claim 1 having 3-50 alkoxysilyl groups in each molecule.

5. A curable coating composition of claim 1 comprising 20-80 parts by weight of the polymer (A).

6. A curable coating composition of claim 2 comprising 20-70 parts by weight of the radical reactivity compound.

7. A curable coating composition of claim 1 comprising 0.5-10 parts by weight of the cationic polymerization initiator

8. A curable coating composition of claim 2 comprising 0.5-10 parts by weight of the radical polymerization initiator.

9. A curable coating composition comprising
(A) 10-99.5 parts by weight of a polymer containing an alkoxysilyl group having a weight average molecular weight of from about 500 to more than 10,000, and having at least one alkoxysilyl group in each molecule,
(B) 0.5-90 parts by weight of a Radical reactivity compound,
(C) 0.05-20 parts by weight of a cationic polymerization initiator,
(D) 0.05-20 parts by weight of a Radical polymerization initiator,

10. A curable coating composition of claim 9 wherein the polymer has a weight average molecular weight of about from 600 to 5,000.

11. A curable coating composition of claim 9 having 3-50 alkoxysilyl groups in each molecule.

12. A curable coating composition of claim 9 comprising 20-80 parts by weight of the polymer (A).

13. A curable coating composition of claim 9 comprising 20-70 parts by weight of the radical reactivity compound.

14. A curable coating composition of claim 9 comprising 0.5-10 parts by weight of the cationic polymerization initiator.

15. A curable coating composition of claim 9 comprising 0.5-10 parts by weight of the radical polymerization initiator.

16. A method of forming a film on a substrate comprising applying the curable coating composition of claim 1 to the substrate to form a coating, and applying at least one from the group consisting of heat and actinic radiation to cure the coating.

17. A method of claim 16 comprising applying actinic radiation to cure the coating.

18. A method of claim 16 comprising applying heat to cure the coating.

19. A method of claim 16 comprising applying actinic radiation and heat, or heat and actinic radiation, to cure the coating.

20. A method of forming a film on a substrate comprising applying the curable coating composition of claim 2 to the substrate to form a coating, and applying at least one from the group consisting of heat and actinic radiation to cure the coating.

21. A method of claim 20 comprising applying actinic radiation to cure the coating.

22. A method of claim 20 comprising applying heat to cure the coating.

23. A method of claim 20 comprising applying actinic radiation and heat, or heat and actinic radiation, to cure the coating.

24. A method of forming a film on a substrate comprising applying the curable coating composition of claim 9 to the substrate to form a coating, and applying at least one from the group consisting of heat and actinic radiation to cure the coating.

25. A method of claim 24 comprising applying actinic radiation to cure the coating.

26. A method of claim 24 comprising applying heat to cure the coating.

27. A method of claim 24 comprising applying actinic radiation and heat, or heat and actinic radiation, to cure the coating.
